(19) United States
(12) Patent Application Publication
(10) Pub. No.: US 2004/0263639 A1
(43) Pub. Date: Dec. 30, 2004

(54) System and method for intelligent image acquisition

(76) Inventors: Vladimir Sadovsky, Bellevue, WA (US); William M. Crow, Sequim, WA (US); Blake D. Manders, Redmond, WA (US); Cyra Richardson, Bellevue, WA (US)

Correspondence Address: SHOOK, HARDY & BACON L.L.P., 2555 GRAND BOULEVARD, KANSAS CITY, MO, 64108-2613, US

(21) Appl. No.: 10/603,788

(22) Filed: Jun. 26, 2003

(51) Int. Cl. H04N 5/228; H04N 5/76; G06K 9/40

(52) U.S. Cl. 348/222.1; 348/231.3; 382/274

(57) ABSTRACT

A method and system are provided for allowing a user to improve the quality of photographs. The system is capable of optimizing an image capturing device in order to achieve this goal. The system includes data collection apparatus for collecting data related to a captured image from the image capturing device and for sending the data to a storage device. The system additionally includes data analysis tools for comparing captured data to previously stored data and optimization tools for optimizing the image capturing device based on the data analysis. The data analysis tools may include multiple filters for analyzing different types of image-related information. A real-time wireless link may be maintained between the system and the image capturing device. The ability to accumulate and maintain statistical data enables a historical analysis that results in higher quality photographs.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

This invention relates to the field of image capturing devices and more particularly to improving image quality through data collection and analysis.

### BACKGROUND OF THE INVENTION

Digital cameras have become more affordable and the number of digital photos taken for personal use has grown rapidly. While digital technology enables high quality photographs, the individuals taking the photographs are often novices who are unable to fully utilize the technology due to their lack of knowledge. Furthermore, individuals are not always aware that their photographs have not achieved optimal quality.

In order to assist the novice users, digital camera manufacturers have taken steps to incorporate extensive instructional materials. These instructional materials are often cumbersome and users do not take the time to fully explore them.

One technique for improving image quality involves analyzing an image and correcting it. However, in order to analyze image data thoroughly and correctly, the data must be extensive. With a small set of image data, identification of trends in a user's photographic style is difficult and may prove to be inaccurate. Image capturing devices do not contain a persistent memory and lose information between sessions. Available image capturing devices have limited memory capabilities and are not generally capable of permanently recording the data.

Current processes are available for allowing a user to transfer an image from an image capturing device to an end user application or directly into storage. Some computer operating systems facilitate a method of acquiring still and photographic images from acquisition devices such as scanners, digital cameras, and video cameras, and inserting the images into end user applications. Although these acquisition methods may be user-friendly, the operations generally require user action or authorization and are not performed automatically.

Furthermore, for controllable acquisition devices like scanners, user/application data during manipulation of settings is not reflected in the metadata. Therefore, it is impossible to suggest behavioral optimization based on an observed usage history and inform users about device operation in order to increase image quality.

Accordingly, a technique is needed for helping users to take higher quality photographs. Such a technique would provide users incentive to take more photographs once image quality improves. Furthermore, previous solutions have concentrated more on the image-capturing device than on the utility of a personal computer. End users would benefit from intelligent assistance that computer software can provide including provision of automatic adjustments to settings, recommendations related to device usage and analysis of images and patterns of use.

### SUMMARY OF THE INVENTION

In one aspect, the present invention is directed to a method for optimizing an image capturing device in order to improve image quality. The method comprises collecting data related to a captured image from the image capturing device and storing the data externally from the image capturing device. The method additionally comprises comparing the collected data to previously stored data and determining adjustments for optimizing the image capturing device based on the comparison.

In a further aspect, the invention includes a system for optimizing an image capturing device in order to improve image quality. The system comprises data collection apparatus for collecting data related to a captured image from the image capturing device and for sending the data to a storage device and data analysis tools for comparing captured data to previously stored data. The system additionally comprises optimization tools for determining how to optimize the image capturing device based on the data analysis.

In an additional aspect, the invention comprises a method for analyzing captured images. The method comprises collecting data related to a newly captured image, the data including image quality data and context data and comparing the image quality data to stored image quality data to determine a deviation from ideal image quality data and comparing context data for the newly captured image to stored context data. The method further includes determining how to optimize the image capturing device to improve image quality based on the comparison.

In yet an additional aspect, the invention comprises a system for optimizing an image capturing device in order to improve image quality. The system comprises data collection apparatus for collecting data related to a captured image from the image capturing device, the data including image data and context data, and for sending the data to a storage device. The system additionally includes image data analysis tools for comparing newly captured image data to stored image data and device and context analysis tools for comparing current context data with stored context data. The system also includes optimization tools for determining how to optimize the image capturing device to improve image quality based on the image data analysis and context data analysis.

In a further aspect, the invention includes a system for improving the quality of images captured by an image capturing device. The system includes image analysis filters for deducing image metadata from collected image bits and for recording the image metadata and device setting and session context analysis filters for analyzing device settings and context during image capture. The system additionally includes a mechanism for determining appropriate corrective measures based on the deduced image metadata, device settings and context analysis, and historical data.

### BRIEF DESCRIPTION OF THE DRAWINGS

The present invention is described in detail below with reference to the attached drawing figures, wherein:

FIG. 1 is a block diagram of a suitable computing system environment for use in implementing the present invention;

FIG. 2 is a block diagram showing a components of a first embodiment of a system of the invention;

FIG. 3 is a block diagram illustrating an image capturing device in accordance with an embodiment of the invention;

FIG. 4 is a block diagram illustrating an embodiment of a computing system used in the system of the invention;

FIG. 5 is a block diagram illustrating an image and context analysis manager in accordance with an embodiment of the invention;

FIG. 6 is a block diagram showing interaction between the components of the computing system in accordance with an embodiment of the invention;

FIG. 7 is a flow chart illustrating an image capturing device optimization method in accordance with an embodiment of the invention;

FIG. 8 is a flow chart illustrating a method for optimizing an image capturing device in accordance with an embodiment of the invention; and

FIG. 9 is a flow chart illustrating a data analysis process in accordance with an embodiment of the invention.

### DETAILED DESCRIPTION OF THE INVENTION

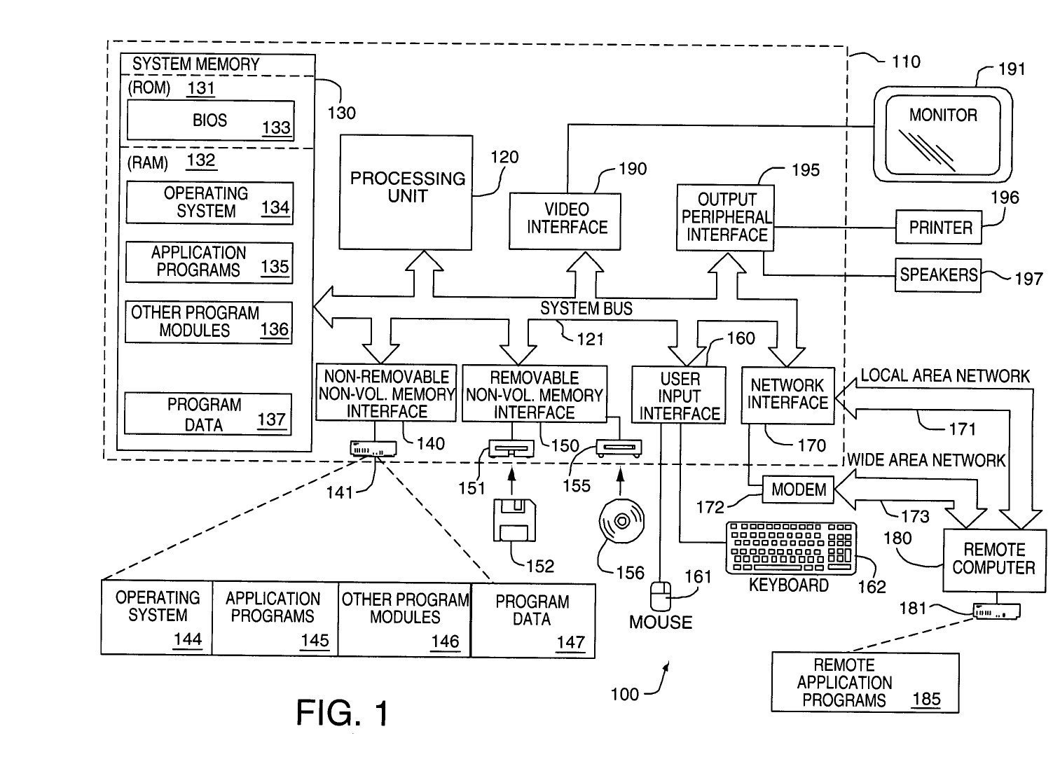

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system 100 for implementing the invention includes a general purpose computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention may operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

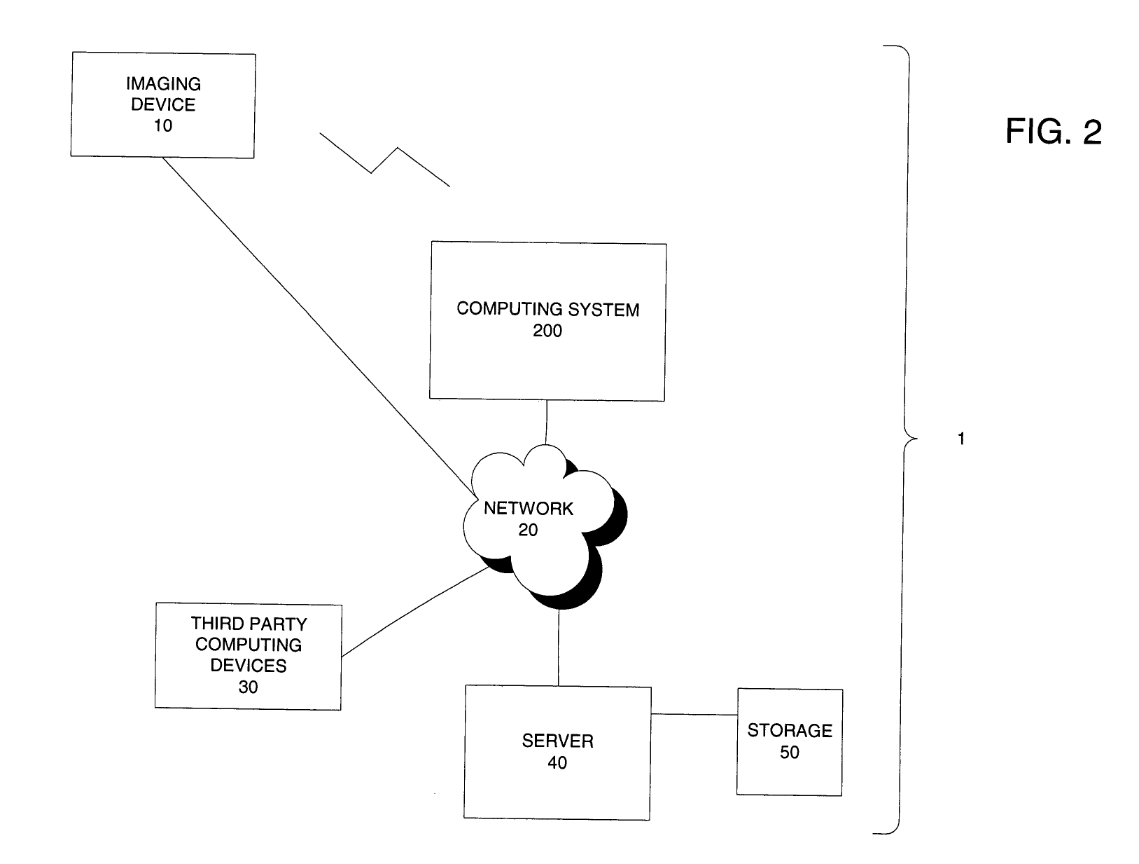

FIG. 2 is a block diagram showing a system 1 in accordance with an embodiment of the invention. The system 1 includes an image capturing device 10 capable of communicating with a computing system 200. The computing system 200 may communicate over a network 20 with third party computing devices 30 and a server 40. The server 40 may be connected with an external storage device 50. These components may be of any configuration similar to those described above with reference to FIG. 1.

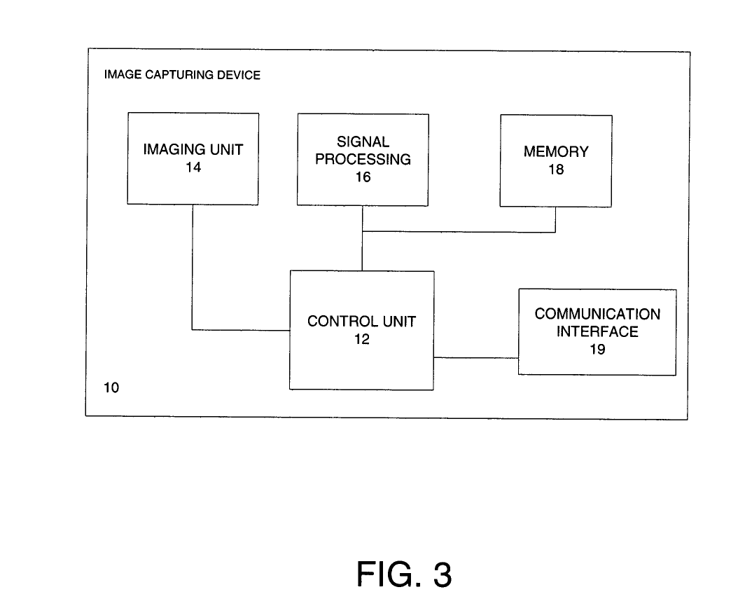

FIG. 3 illustrates an image capturing device 10 including an imaging unit 14, a signal processing device 16, a memory 18, a control unit 12 and a communication interface 19. The communication interface 19 enables the image capturing device 10 to interact with the computing system 200. The communication interface may be an interface that requires the camera to be directly plugged into the computer system 200 or allows it to be connected to the computer system 200 over the Internet. In one embodiment, the image capturing device 10 is connected with the computer system 200 via a wireless interface. The wireless interface may result in a continuous connection through which analysis and correction occur in real time.

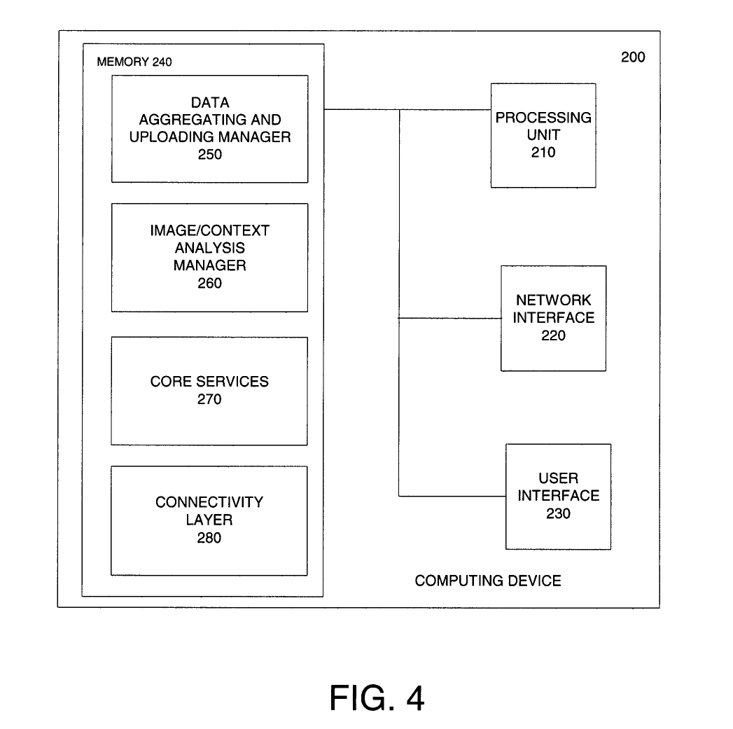

FIG. 4 illustrates a computing system 200 in accordance with an embodiment of the invention. The computing system 200 may include a processing unit 210, a network interface 220, a user interface 230 and a memory 240. The memory 240 may store a data aggregating and uploading manager 250, an image and context analysis manager 260, image acquisition core services 270, and a connectivity layer 280. The computing system 200 finds metadata from the image capturing device 10 or directly from image metadata fields. The image metadata may include data about a picture environment, distances between the image capturing device 10 and the photographic subject, GPS data, resolution depth, focal length, matrix metering, and other types of available data.

The image and context analysis manager 260 receives information from the image capturing device 10 through the connectivity layer 280 or directly from the image metadata fields. The image and context analysis manager 260 is called during every transaction and preserves the collected information for future use.

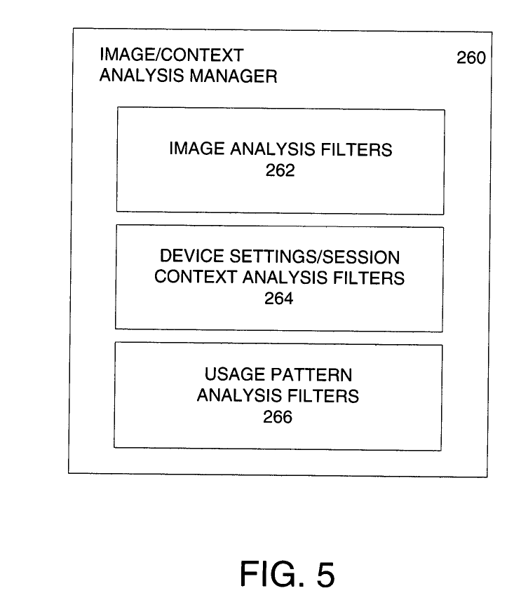

FIG. 5 further illustrates the components of the image and context analysis manager 260. The image and context analysis manager 260 includes a plurality of filters including image analysis filters 262, device settings and context analysis filters 264, and usage pattern filters 266. The filters 262, 264, and 266 are custom components that have access to historical usage and pattern information and work with image metadata. The filters 262, 264, and 266 may be provided by an operating system supplier, a device manufacturer, or a third party software supplier.

Image analysis filters 262 are able to deduce metadata about an image from image bits. The image analysis filters 262 may deduce usage metadata. Usage metadata can be represented by type of scene, lighting conditions, and deviation from accepted norms, such as over-exposure or under-exposure. This type of usage metadata is different from imaging or photographic metadata, which is typically captured by the image capturing device 10. The image analysis filters 262 can also detect device malfunction (e.g. lamp burnout), based on comparison of certain image characteristics with accumulated (“normal”) characteristics, and based on data and metadata from a previously acquired image that was deemed acceptable.

The device settings and session context analysis filters 264 are typically provided by a device manufacturer and are included by the operating system into acquisition workflow. Based on proprietary information communicated by the connectivity layer 280, the device settings and session context analysis filters 264 can analyze and aggregate important information about typical usage of the image capturing device 10. Utilizing operating system metadata storage services, the device settings and session context analysis filters 264 may record this usage information as device object metadata.

Usage pattern analysis filters 266 are typically independent of the image capturing device 10 and function based on accumulated history of device usage. In other words, the usage pattern analysis filters 266 help to determine appropriate settings based on accumulated device usage data from the image capturing device 10.

As shown in FIG. 4, the image acquisition core services 270 may be extended to install, register and invoke the filters 262, 264, and 266 of the image and context analysis manager 260 in a secure and robust fashion. The core services 270 are activated every time the image capturing device 10 is connected with the computing system 200 or every time removable media with images are accessed by the computing system 200. In the latter case, the device settings and context analysis filters 264 may not be used, but the image analysis filters 262 are implemented. Additional services may be provided that are called by the filters 262, 264, 266 to get access to device/session parameters, image data and metadata and storage facilities per image and per device. The image analysis core services 270 provide additional entry points for user interface clients to report detailed information gathered by the filters 262, 264, and 266. The invocation of context sensitive help that may be locally cached, stored on an operating system web site, or on an image capturing device specific web site, may be activated when the core services 270 are detecting a pattern of use allowing optimization of in need of correction. In most cases, the manufacturer of the image capturing device 10 provides the content of the context sensitive help. The core services 270 have the central function of interacting with the user interface 230 and the data storage device 50. The core services 270 may directly populate the data storage device 50 and may transfer images to the user interface 230. The core services 270 may download adjustments to device settings via the user interface 230 and interact with the connectivity layer 280 in order to reset device parameters.

The connectivity layer 280 provides necessary communication channels to allow the filters 262, 264, and 266 to communicate with the image capturing device 10 in order to obtain standard and proprietary parameters, allowing useful aggregation of information. The filters 262, 264, and 266 will generally be implemented during acquisition, but may not always be required during implementation.

The data aggregating and uploading manager 250 may be conditionally installed with end user consent. Utilizing persistent device and image metadata populated by image capturing device 10 and filters 262, 264, and 266, the data aggregating and uploading manager 250 packages information, providing the manufacturer of the image capturing device 10 or other interested parties with important usage statistics. The data aggregating and uploading manager 250 may utilize standard operating system mechanisms to upload these statistics to proprietary web sites. Information gathering for usage components can be managed in compartmentalized fashion to restrict access to device and image parameters specific to a particular vendor. Based on the information gathered from a representative selection of device users, tuning of operational parameters of the image capturing device 10 is possible, substantially extending usability of image capturing devices 10. Additionally, user assistance content, authored and provided by device manufacturers, can be tuned and extended, based on a usage pattern information.

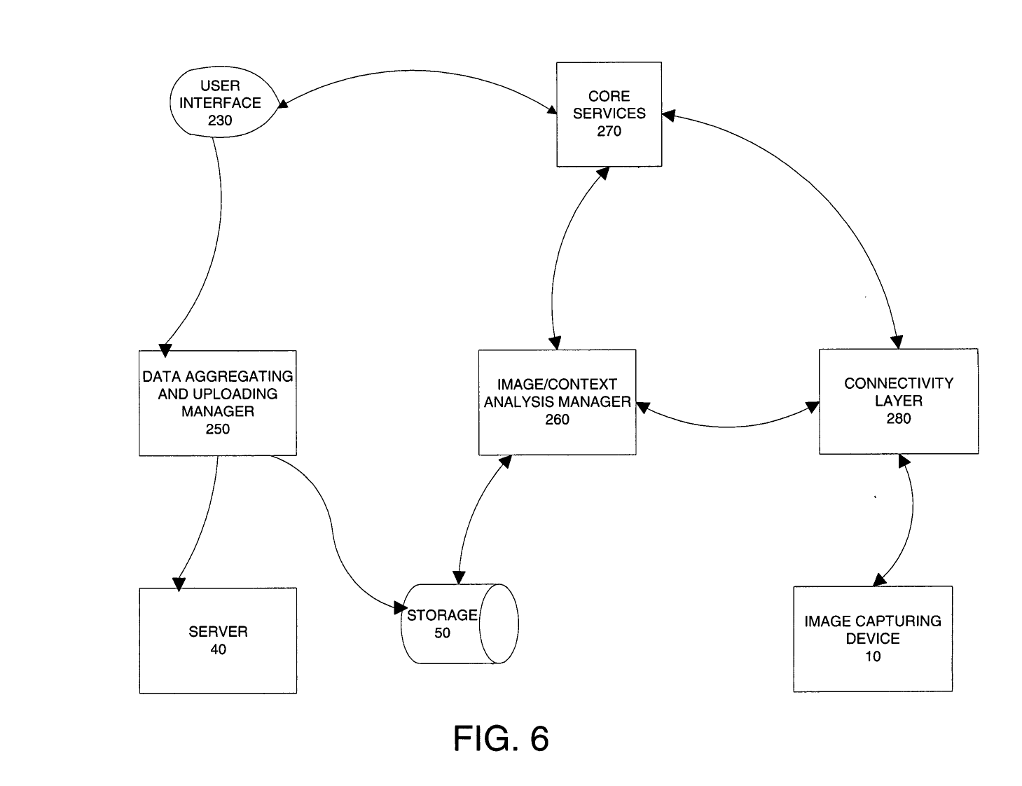

FIG. 6 is a block diagram showing interaction between the above identified components. The image capturing device 10 functions as a source of images and information on settings and parameters. The image capturing device 10 uploads this information to the connectivity layer 280. The uploading may occur through a standardized wire protocol. In operation, the connectivity layer 280 also takes device settings and image metadata from the image capturing device 10. Ultimately, the device settings and metadata are sent to appropriate storage such as external storage device 50. Storage of device settings enables subsequent statistical analysis. If subsequent analysis shows that adjustments to the device settings are desirable, the connectivity layer 280 may also download the adjustments to the image capturing device 10.

The image and context analysis manager 260 retrieves the settings and other image information from the connectivity layer 280. During an acquisition phase or a phase in which data is merely collected, the image and context analysis manager 260 sends the data to the storage system 50. During an implementation phase or a phase during which data is both collected and analyzed, the image and context analysis manager 260 performs analysis on the collected data such as image analysis, pattern analysis, metadata analysis, device settings analysis, and scene analysis. The image and context analysis manager 260 reports its results to the core services 270. In an embodiment of the invention, the core services 270 communicate with the user interface 230 to send error messages, notify users of detected patterns, and send images. The user, through the user interface 230 can select help topic items and direct adjustment of device settings. The core services 270 communicate the received information to the connectivity layer 280 so that the connectivity layer 280 can make adjustments to the settings of the image capturing device 10 if the user indicates via the user interface 230 that such changes are desired. The user interface 230 may also send its responses to invoke the data aggregating and uploading manager 250. The data aggregating and uploading manager 250 may send the user interface information to both the server 40 and the external storage system 50.

In one embodiment of the invention, the user interface 230 is bypassed in order to create a closed loop so that changes are made automatically to the settings of the image capturing device 10. In this embodiment, the core services 270 receive analysis data from the image and context analysis manager 260 and send instructions for changing the device settings through the connectivity layer 280 to change the settings on the image capturing device 10.

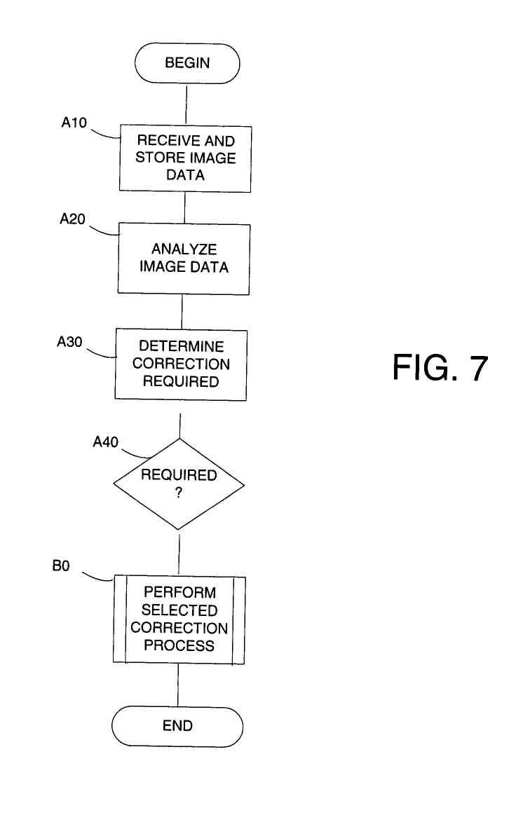

FIG. 7 is a flow chart showing a method for optimizing the image capturing device 10 in accordance with an embodiment of the invention. In step A10, the computing system 200 receives and stores image data. The storage may be local or may include the storage area 50 attached to the server 40. In step A20, the computing system 200 analyzes the collected image data using the image analysis filters 262, the device settings and context analysis filters 264, and the usage pattern analysis filters 266. Based on the analysis, the computing system 200 determines in step A30 whether correction is required. If no correction is required, the process is ended. If correction is required, a correction process is performed at B0.

Although the analysis process of FIG. 7 is described as involving data stored on the computing system 200, in additional embodiments of the invention, image data may be stored on a network device or in the image capturing device or any other available storage area.

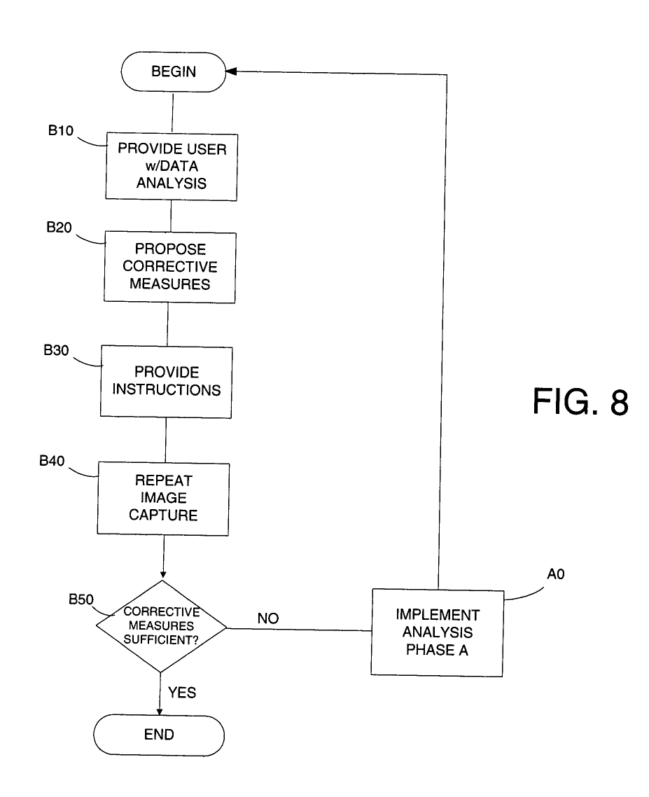

FIG. 8 is a flow chart illustrating an embodiment of a correction process. In this embodiment, the user interface 230 of the computer system 200 provides feedback directly to the user. The user interface 230 displays data analysis and instructions so that the user can decide whether or not to change device settings. The user interface 230 may ask the user if he wants to connect to a specific help topic. The user interface may bring up a specific help topic anytime collected data indicates that the image capturing device 10 has encountered a specific problem. In step B10, the computing system 200 provides the user with data analysis through the core services 270. In step B20, the computing system 200 proposes corrective measures. In step B30, the computing system 200 provides instructions for carrying out corrective measures. In embodiments of the invention, the correction process may end with step B30. In particular, for camera users, the system may merely provide instructions. However, in other embodiments, the method may include additional steps B40 and B50. In step B40, the user may repeat image capture. In step B50, the system can then determine if the corrective measures were sufficient in step B30 and implement the analysis procedure A described above with reference to FIG. 7 if the corrective measures were not sufficient. Steps B40 and B50 may have particular application when the image capturing device is a scanner.

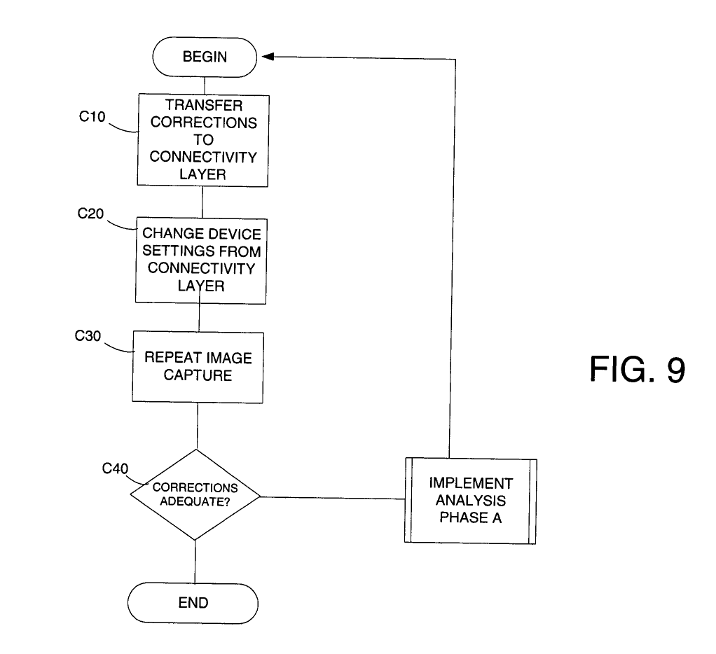

FIG. 9 shows the above-described closed loop embodiment of a method for automatically changing settings on the image capturing device 10. In step C10, the computing system 200 transfers the correction to the connectivity layer 280. In step C20 the image capturing device settings are updated. In embodiments of the invention, the closed loop process may end with step C20. In particular, if the image capturing device is a camera, the process may end after step C20. In other embodiments, in step C30, the user may repeat image capture and in step C40, the computing system 200 may determine if the automatic corrections were adequate. If the corrections are inadequate, the analysis phase shown in FIG. 7 can again be implemented. These latter steps may have particular application if the image capturing device is a scanner.

In various embodiments, an end user receives guidance based on a prior history of acquired images, allowing for integration of context sensitive help to optimize device usage and usage of compiled and aggregated information to point to areas of improvement and optimization with regard to taking still pictures. The system enables precise problem and error reporting to the user and indirectly to device maker, leading to possible optimization in device design and marketing. The extensible nature of the invention enables third parties, such as device manufacturers and imaging software makers to better integrate into existing systems.

The technique of the invention enables full utilization of desktop computing power for end user benefits, particularly when end users are dealing with a large number of incoming photographic images. The present invention employs methods of image and statistical analysis in extensible fashion to derive patterns of use, build recommendations for user action, and aggregate data for perusal by device manufacturers. End users will benefit from intelligent help that a computer can provide by analyzing images and patterns of use. Third party device vendors will be able to identity difficult-to-use device features and areas of problematic usage in order to find ways to increase customer interest and decrease the time required to optimize photographic devices for each customer.

The present invention has been described in relation to particular embodiments, which are intended in all respects to be illustrative rather than restrictive. Alternative embodiments will become apparent to those skilled in the art to which the present invention pertains without departing from its scope.

From the foregoing, it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and with the scope of the claims.

We claim:

1. A method for optimizing an image capturing device in order to improve image quality, the method comprising:
collecting data related to a captured image from the image capturing device and storing the data externally from the image capturing device;
comparing the collected data to previously stored data; and
determining adjustments for optimizing the image capturing device based on the comparison.

2. The method of claim 1, further comprising forwarding the determined adjustments to a user interface for user evaluation.

3. The method of claim 1, further comprising, automatically making the adjustments to the image capturing device.

4. The method of claim 1, wherein comparing the data to previously stored data comprises performing a metadata analysis.

5. The method of claim 1, wherein comparing the data to previously stored data comprises performing pattern analysis.

6. The method of claim 1, wherein comparing the data to previously stored data comprises performing device settings analysis.

7. The method of claim 1, further comprising presenting help topics to a user interface.

8. The method of claim 1, further comprising collecting the data through a connectivity layer and making changes to image capturing device settings through the connectivity layer.

9. The method of claim 8, further comprising sending the collected data to an image and context analysis manager for analysis.

10. The method of claim 9, further comprising maintaining a real time wireless connection between the image capturing device and the connectivity layer.

11. A computer-readable medium having computer-executable instructions for performing the method recited in claim 1.

12. A system for optimizing an image capturing device in order to improve image quality, the system comprising:
data collection apparatus for collecting data related to a captured image from the image capturing device and for sending the data to a storage device;
data analysis tools for comparing captured data to previously stored data;
optimization tools for optimizing the image capturing device based on the data analysis.

13. The system of claim 12, wherein the data collection apparatus comprises a connectivity layer operable for sending image-related data to the data analysis tools.

14. The system of claim 12, wherein the data analysis tools comprise an image and context analysis manager.

15. The system of claim 14, wherein the image and context analysis manager comprises a plurality of filters for processing and analyzing different types of image-related data.

16. The system of claim 15, wherein the filters comprise an image analysis filter, a device settings and context analysis filter, and a usage and pattern analysis filter.

17. The system of claim 12, wherein the optimization tools comprise a user interface for providing instructions and recommendations to the user for improving image quality.

18. The system of claim 12, wherein the optimization tools comprise core services and a connectivity layer for sending adjustments directly to the image capturing device.

19. The system of claim 12, further comprising a data aggregating and uploading manager for facilitating maintenance of usage statistics.

20. A method for analyzing captured images, the method comprising:
collecting data related to a newly captured image, the data including image quality data and context data;
comparing the image quality data to stored image quality data to determine a deviation from ideal image quality data and comparing context data for the newly captured image to stored context data; and
determining one or more adjustments to optimize an image capturing device to improve image quality based on the comparison.

21. The method of claim 20, further comprising forwarding the determined adjustments to a user interface for user evaluation.

22. The method of claim 20, further comprising, automatically making the adjustments to the image capturing device.

23. The method of claim 20, wherein comparing the context data to previously stored context data comprises performing device settings analysis.

24. The method of claim 20, further comprising presenting help topics to a user interface.

25. The method of claim 20, further comprising collecting the data through a connectivity layer and making changes to image capturing device settings through the connectivity layer.

26. The method of claim 25, further comprising sending the collected data to an image and context analysis manager for analysis.

27. The method of claim 26, further comprising maintaining a real time wireless connection between the image capturing device and the connectivity layer.

28. A computer-readable medium having computer-executable instructions for performing the method recited in claim 20.

29. A system for optimizing an image capturing device in order to improve image quality, the system comprising:
data collection apparatus for collecting data related to a captured image from the image capturing device, the data including image data and context data;
image data analysis tools for comparing newly captured image data to stored image data and for sending the image data to a storage device;
device and context analysis tools for comparing current context data with stored context data and for sending the context data to the storage device;
optimization tools for determining how to optimize the image capturing device to improve image quality based on the image data analysis and context data analysis.

30. The system of claim 29, wherein the data collection apparatus comprises a connectivity layer operable for sending image data to the image data analysis tools and context data to the device and context analysis tools.

31. The system of claim 29, further comprising a usage and pattern analysis filter.

32. The system of claim 29, wherein the optimization tools comprise a user interface for providing instructions and recommendations to the user for improving image quality.

33. The system of claim 29, wherein the optimization tools comprise core services and a connectivity layer for sending adjustments directly to the image capturing device.

34. The system of claim 29, further comprising a data aggregating and uploading manager for facilitating maintenance of usage statistics.

35. A system for improving the quality of images captured by an image capturing device, the system comprising:
image analysis filters for deducing image metadata from collected image bits and for recording the image metadata;
device settings and session context analysis filters for analyzing device settings and context during image capture; and
means for determining appropriate corrective measures based on the deduced image metadata, device settings and context analysis, and historical data.

36. The system of claim 35, further comprising data collection apparatus including a connectivity layer operable for sending image-related data to the image analysis filters and the device setting and session context analysis filters.

37. The system of claim 35, further comprising a usage and pattern analysis filter.

38. The system of claim 35, wherein the means for determining appropriate corrective measures comprise a user interface for providing instructions and recommendations to the user for improving image quality.

39. The system of claim 35, wherein the means for determining appropriate corrective measures comprise core services and a connectivity layer for sending adjustments directly to the image capturing device.

40. The system of claim 35, further comprising a data aggregating and uploading manager for facilitating maintenance of usage statistics.

41. A method for analyzing a captured multimedia object, the method comprising:
collecting data related to a newly captured multimedia object, the data including multimedia quality data and multimedia context data;
comparing the multimedia quality data to stored multimedia quality data to determine a deviation from ideal multimedia quality data and comparing multimedia context data for the newly captured multimedia object to stored multimedia context data; and
determining one or more adjustments to optimize a multimedia capturing device to improve multimedia quality based on the comparison.

42. The method of claim 41, wherein the captured multimedia object comprises at least one of a video object and an audio object.
